(19) United States
(12) Patent Application Publication
(10) Pub. No.: US 2011/0250482 A1
(43) Pub. Date: Oct. 13, 2011

(54) POWER SOURCE CASSETTE WITH LATCH MECHANISM

(76) Inventors: Kenneth Reed HENDERSON, JR., Herndon, VA (US); Steven Kutchi, Frederick, MD (US)

(21) Appl. No.: 12/756,625

(22) Filed: Apr. 8, 2010

(51) Int. Cl. H01M 2/10; B23P 19/00

(52) U.S. Cl. 429/97; 29/525.01; 29/426.1

(57) ABSTRACT

A cassette for providing power source for use with a portable electronic device. The cassette comprises a retaining member for holding a power source, such as one or more batteries. The retaining member includes one or more latching members, such as a pair of resilient fingers protruding from one end operable with a cover having a latching mechanism. When the retaining member is matably engaged with the cover, the fingers engage one or more second latching members. When one or more latches are actuated (e.g. contemporaneously), the fingers disengage the one or more second latching members. After disengagement the retaining member may be removed from the cover the batteries may be installed, removed, or replaced.

### BACKGROUND OF THE INVENTION

1. Field of the Invention

Aspects of the present invention relate to portable device power supplies, and more particularly to a cassette for retaining batteries or other power sources, which can be connected to a portable electrical device.

2. Background of the Technology

Battery-powered portable electronic devices are prevalent in today's society. For example, many people own mobile telephones, personal digital assistants (PDAs), portable computers, handheld music players, digital cameras, radios, two-way radios, and/or many other types of devices. These electronic mobile devices require batteries to operate. Many devices use recharchable or disposable batteries.

In addition to the personal items described above, members of the military and emergency and/or other personnel, such as firefighters and utility workers, may often carry various other types of battery-operated equipment. In particular, many must carry two way radios. These radios typically are not compatible with standard market rechargeable batteries and require periodic battery replacement. The battery cassettes in such devices have often proven to be challenging to open and reload in the field.

Thus, among other things, it would be desirable to have a power source cassette that can be easily reloaded when necessary, including when in the field.

### SUMMARY OF THE INVENTION

Aspects of the present invention provide, among other things, features for a power source cassette that is compact and efficient in installation and use, while resistive to unintentional opening.

Aspects of an exemplary such cassette include a retaining member for holding a power source, which retaining member mates with a cover. The retaining member may comprise one or more latching members, such as resilient fingers or other securing features, protruding from one end, and other cooperative latching features (e.g., on or otherwise associated with the cover). For example, when the retaining member is mated with a cover, the latching members may engage a pair of directing members in the cooperative latching features. The latching features may include other features to provide security or other advantages, such as features that must be actuated contemporaneously to be activated, so as to thereby inhibit or prevent inadvertent opening of the cassette.

Aspects of the present invention further provide methods for operating the cassette when installing or changing the power source. The methods may comprise, for example, engaging the latching members of the retaining member with the additional latching features located on a cover. The methods may also comprise mating the retaining member with the cover then sliding or otherwise engaging the retaining member with the additional latching features in conjunction with the latching members engaging a pair of directing members.

Additional advantages and novel features of the aspects will be set forth in part in the description that follows, and in part will become more apparent to those skilled in the art upon examination of the following or upon learning by practice of the aspects.

### BRIEF DESCRIPTION OF THE FIGURES

In the drawings:

FIG. 1 shows an exploded perspective view of a cassette in accordance with aspects of the present invention;

FIG. 2 shows a rear view of a cover of the cassette of FIG. 1 with partial omission;

FIG. 3 shows a cross sectional view of the cover of the cassette of FIG. 1;

FIG. 4 shows a cross sectional rear view of the cassette of FIG. 1;

FIG. 5 shows a cross sectional top view of the cassette of FIG. 1;

FIG. 6a shows a cross sectional top view of the cassette in FIG. 1 in a disengaged state;

FIG. 6b shows a cross sectional top view of the cassette of FIG. 1 in a partially engaged state;

FIG. 6C shows a cross sectional top view of the cassette of FIG. 1 in a fully engaged state;

FIG. 7 shows a perspective view of the cover of the cassette of FIG. 1;

FIG. 8 shows a perspective view of the a retaining member of the cassette of FIG. 1;

FIG. 9 shows a cross sectional perspective view of the retaining member of the cassette of FIG. 8;

FIG. 10 is an exploded view of the cassette of FIG. 1, with exemplary circuitry indicated;

FIG. 11 is a photostat of a front view of an exemplary cassette along the lines of the device shown in FIG. 1, attached to an electronic device;

FIG. 12 is a photostat of a side view of the cassette of FIG. 11;

FIG. 13 is a phototstat of a rear view of the cassette of FIG. 11;

FIG. 14 is a photostat of a top view of the cassette of FIG. 11;

FIG. 15 is a photostat of the cassette of FIG. 11, in disassembled form.

### DETAILED DESCRIPTION

Aspects of the present invention include a retaining member for retaining a power source, a cover that is matably engagable with the retaining member, and latching features. The latching features allow the retaining member and the cover to engage with each other to secure the power source. The latching features may also include mechanisms that resist accidental or inadvertent disengagement of the retaining member from the cover, such as use of two latches that must be contemporaneously actuated.

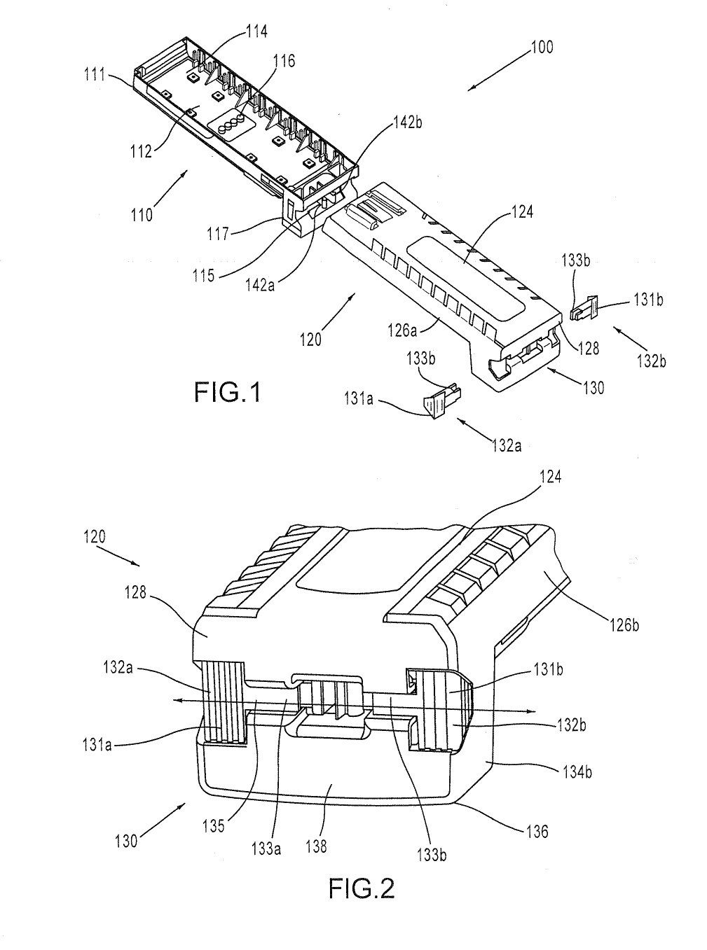

FIG. 1 shows an exploded view of an exemplary cassette or cartridge 100 (interchangeably referred to herein as a “cassette”) for retaining a power source 118, such as batteries for a portable electronic device. In the exemplary variation of FIG. 1, the cassette 100 comprises two primary components: a retaining member 110 and a cover 120. The retaining member 110 retains the power source 118 and provides power to an electronic device 200, such as a hand-held two way radio, by attachment thereto. The cover 120 protects and retains the power source 118, via cooperative engagement with the retaining member 110, and, among other things, protects the power source 118 from external exposure.

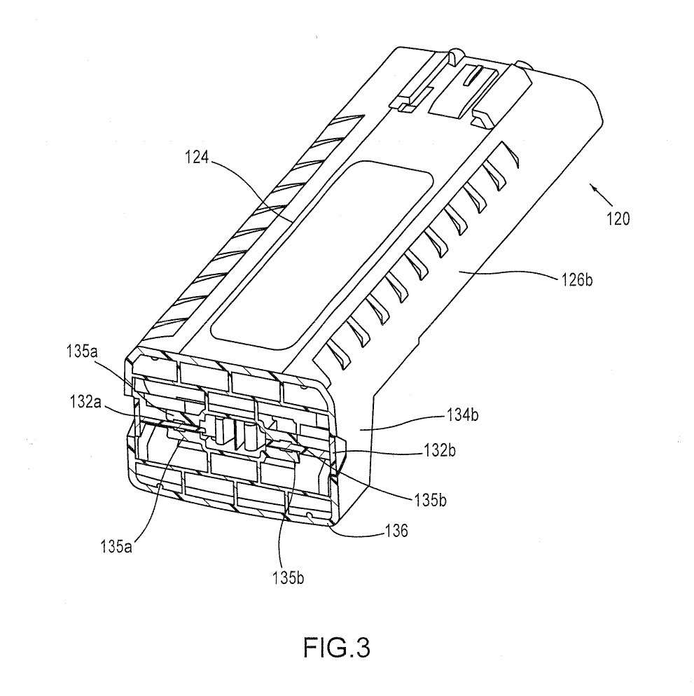

Referring to FIGS. 1-4, 14, and 15, the exemplary cover 120 comprises a base portion 124 and two opposing wall portions 126a, 126b. The exemplary cover 120 further comprises a first end portion 128 that extends the base portion 124, between the opposing wall portions 126a, 126b. Together, the base portion 124 and the opposing wall portions 126a, 126b, and the first end portion 128 define a semi-enclosed shape having three walls.

At a first end of the exemplary cover 120, an exemplary latching mechanism 130 is integrally formed with or otherwise attached to the cover 120. The latching mechanism 130 comprises a first wall extension 134a and an opposing second wall extension 134b. The first wall extension 134a is parallel with and extends from the first wall portion 126a. The second wall extension 134b is parallel and extends from the second wall portion 126b. A connecting portion 136 is connected to and extends between the first and second wall extensions 134a, 134b. A second end portion 138 extends orthogonally from the connecting portion 136, between the first and second wall extensions 134a, 134b. Thus, the alignment of the base portion 124, opposing wall portions 126a, 126b, the first and second wall extensions 134a, 134b and the connecting portion 136 form a partial housing. This housing engages with retaining member 110, which is discussed in further detail below.

The exemplary latching mechanism 130 further comprises one or more latches. In the exemplary version of FIG. 1, the one or more latches comprise a pair of latches 132a, 132b. Each of the pair of latches 132a, 132b comprises an actuation portion 131a, 131b and an engagement portion 133a, 133b. As shown in FIG. 2, the second end portion 138 of the cover 120 may be formed such that a passage 135 extends therethrough. The passage may be at least partly defined by a set of opposing guide rails 135a, 135b. The passage 135 also extends into the first and second wall extensions 134a, 134b. The passage 135 is shaped to receive the pair of latches 132a, 132b, such that the pair of latches 132a, 132b are slidably retained in the passage 135. As shown in FIG. 2, the actuation portions 131a, 131b extend from the passage 135. In particular, the actuation portions 131a, 131b extend through the part of the passage 135 that extends into the first and second wall extensions 134a, 134b. Thus, the actuation portions 131a, 131b are located such that application of force (e.g., by a user's thumb and forefinger in cooperation) on the actuation portions 131a, 131b will slide the pair of latches 132a, 132b towards each other.

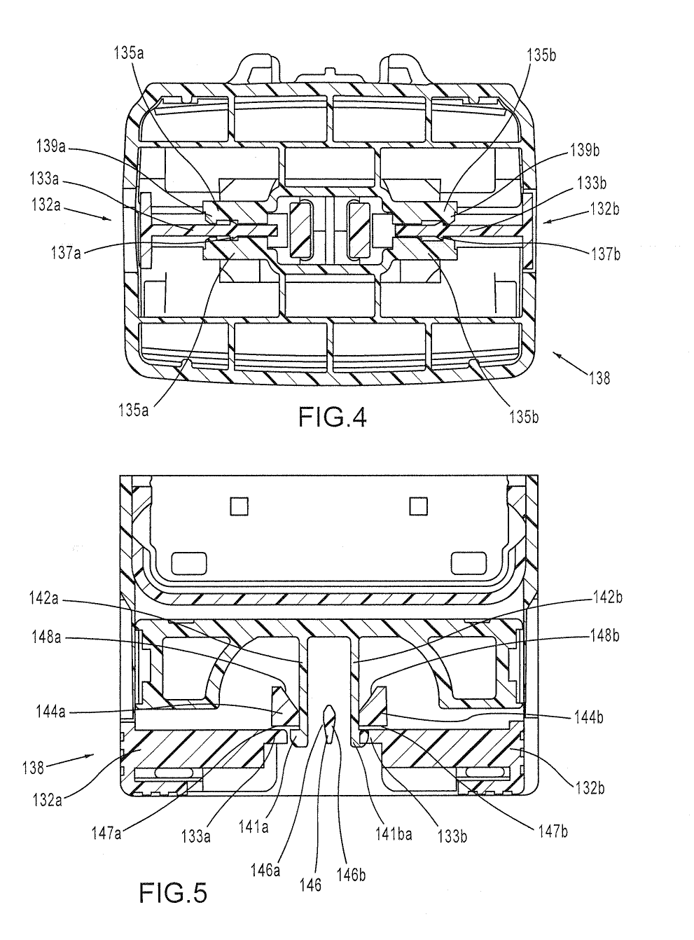

As shown in the cutaway view of the second end portion 138 of FIG. 4, the pair of latches 132a, 132b further comprise two or more first protruding members 137a, 137b. The first protruding members 137a, 137b may, for example, extend from the engagement portion 133a, 133b of the pair of latches 132a, 132b. The first protruding members 137a, 137b may include a ramp portion, for example, to engage second protruding members 139a, 139b contained within second end portion 138. The second protruding members 139a, 139b may be integrally formed with the set of opposing guide rails 135a, 135b surrounding the passage 135, for example. When the pair of latches 132a, 132b are moved away from each other (e.g. via biasing), the first protruding members 137a, 137b and the second protruding members 139a, 139b will engage with each other, thereby preventing the pair of latches 132a, 132b from sliding out of the cover 120.

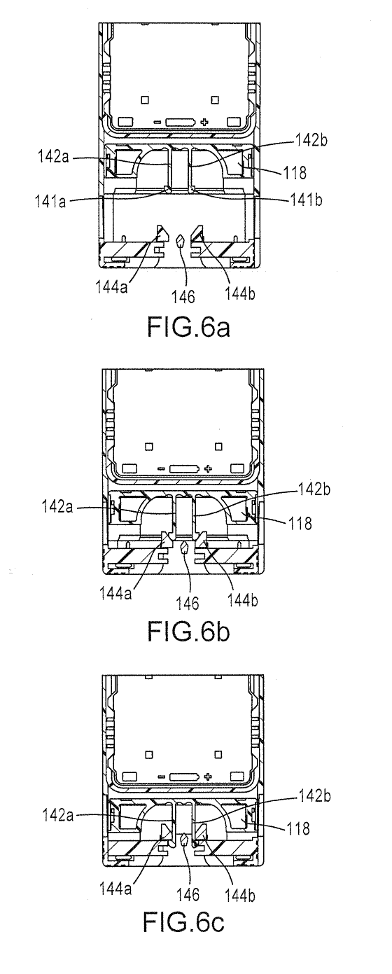

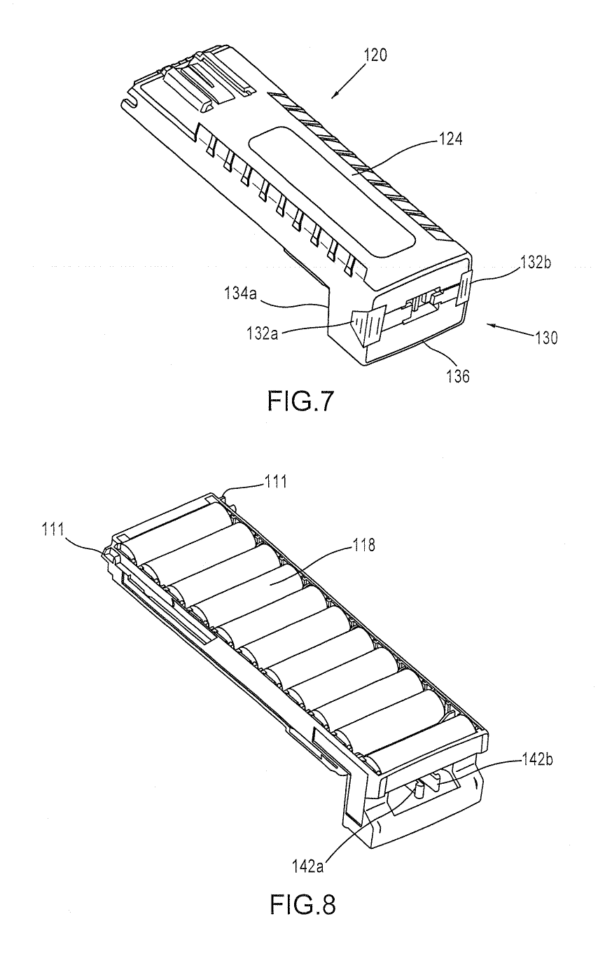

Referring to the cross-sectional view of FIGS. 5 and 6a-6c, which are each perpendicular to the view of FIG. 4, the latching mechanism 130 of cover 120 may further comprise one or more directing members 144a, 144b, such as ramps. Furthermore, the portions 147a, 147b of the one or more directing members may also partially define portions of one or more second latching members 147a, 147b within latching mechanism 130. In the exemplary variation, the one or more directing members 144a, 144b form a pair of ramps that cooperate with one or more first latching members 142a, 142b. Further, in this exemplary variation, an end portion of each of the pair of directing members forms an edge 147a, 147b to retainably engage corresponding lips 141a, 141b, of fingers 142a, 142b of retaining member 110. The latching mechanism 130 may further comprise an island 146, formed by return ramps 146a, 146b. The functions of the pair of directing members 144a, 144b and the island 146 are discussed in further detail below.

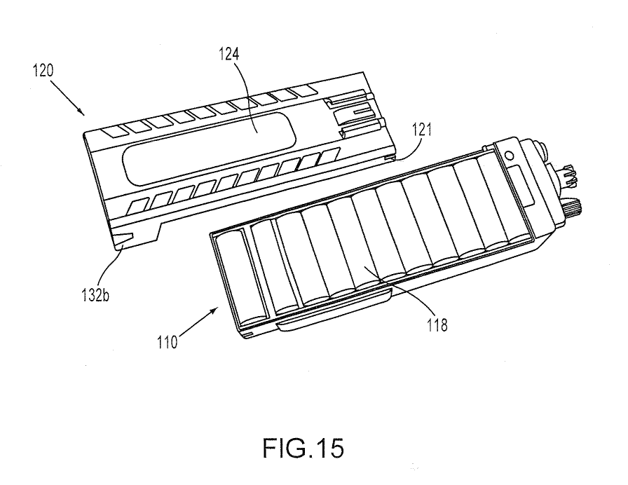

The cover 120 and retaining member 110 may be coupleable to retainably form a chamber. For example, as best seen in FIGS. 10 and 15, the exemplary cover 120 may further comprise guide slots 121 located along one or both sides of the cover 120, the slot(s) being slidably engagable with one or more mating protrusions 111 located on side(s) of a second end of the retaining member 110.

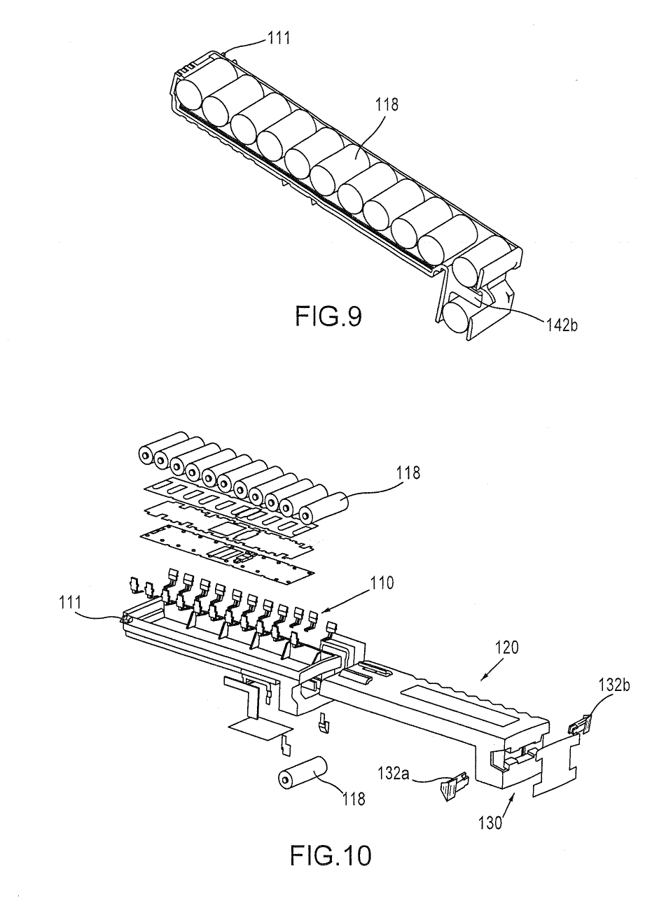

Referring to FIGS. 1, 5, 6a-6c, 8, 9, 10, the exemplary cassette 100 may also comprise a retaining member 110 having an elongated wall portion 112. The exemplary variation of the wall portion 112 of FIG. 1 has a generally rectangular cross-sectional shape. The exemplary retaining member 110 may further comprise four walls extending perpendicularly from each of the edges of the wall portion 112, thereby providing an overall open container shape. The retaining member 110 is engagable with the cover 120, such that the retaining member 110 and the cover 120 form a housing to contain an enclosed power supply, such as one or more batteries. The wall portion 112 may be segmented, for example, into a series of slots 114 to contain batteries. The slots 114 may be sized and of a number appropriate for power necessary for an attached portable electronic device. In the exemplary variation shown in FIG. 1, the batteries 118 may be AA standard batteries, for example, and thus the slots 114 sized accordingly. Furthermore, in an exemplary variation eleven power source slots 114 across the length of the wall portion 112 may be used. The retaining member 110 may also be sized and shaped to receive circuitry.

In one exemplary variation, as shown in FIG. 1, at a second end of the retaining member 110, a pair of mating protrusions 111 extend from the side walls of the retaining member. The mating protrusions 111 are shaped to mate with the pair of guide slots 121a, 121b that are located along the sides of the cover 120. The wall portion 112 may further comprise one or more electrical contacts 116. FIG. 1 shows four contacts, which may include, for example a ground, a power connection, a data connection, and a clock connection. However, any suitable number and types of contacts may be used as appropriate for the device being powered.

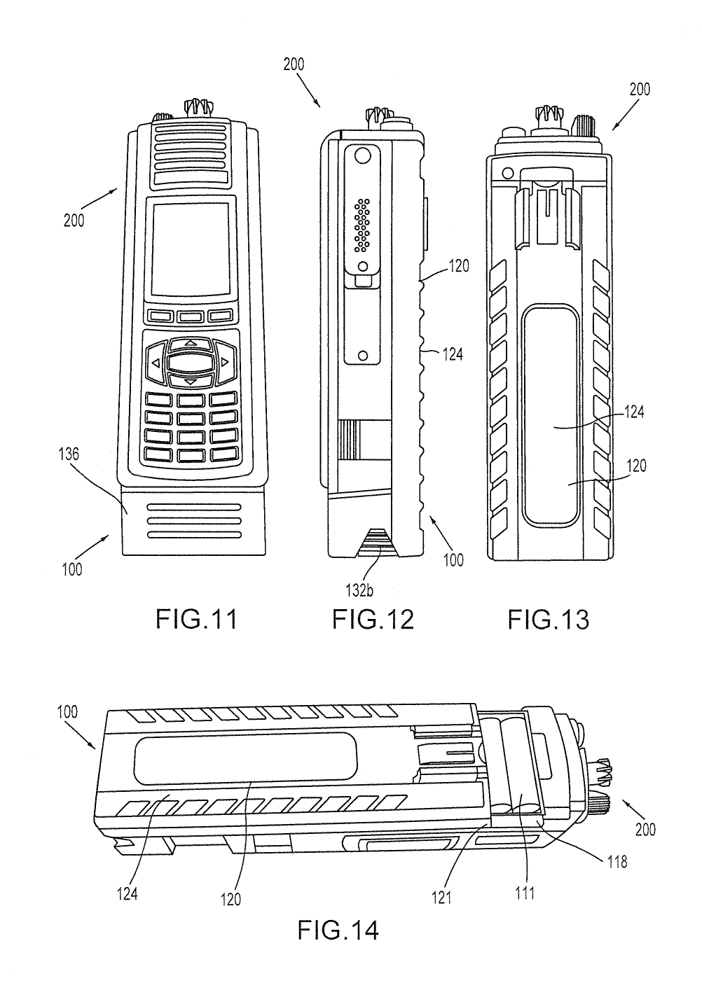

The retaining member 110 may further comprise an additional retaining housing 117. The exemplary retaining housing 117 may extend generally perpendicularly, for example, from the first end of the retaining member 120 and be shaped to retain a portion of the power source 118 (e.g., a battery) and to securely fit within the confines of the latching mechanism 130. Thus, in an exemplary variation, the additional retaining housing brings the total power source slots to twelve. More particularly, the retaining housing 117 may extend such that the retaining housing 117 fits matably with the end portion 138 of the cover 120 when the retaining member 110 is fully engaged with the cover 120, as described further below. Furthermore, as seen in FIGS. 11 and 12, the top of the retaining housing 117 may act as a base, or stand upon which the electronic device 200 may rest, once the cassette 100 is connected to the electronic device 200.

The retaining member 110 may further comprise an opening 115 located within the retaining housing 117. As seen in FIGS. 1, 5, 6a-6c, and 8, in the opening 115, one or more first latching members 142a, 142b may be disposed. In the exemplary variation shown, the one or more first latching members 142a, 142b include a pair of fingers 142a, 142b protruding within the retaining housing 117. Each of the pair of fingers 142a, 142b may include a lip 141a, 141b, for example. During assembly, as shown in FIGS. 6a-6c, when the retaining member 110 is matably engaged with the cover 120, the pair of fingers 142a, 142b are aligned the with pair of directing members 144a, 144b. The pair of fingers 142a, 142b may be biased, such as being formed of a resilient material, so that when an inward force is applied (e.g., sliding upon the ramps of the directing members 144a, 144b), the pair of fingers 142a, 142b will deflect, but will then return to their original relative positions, after assembly.

A method of operating the cassette 100 will now be further described, thereby highlighting the advantages and mechanical operation of the above structure. Beginning with the cassette 100 in a disassembled state, the user or other assembler of the cassette first places a power source 118 in the retaining member 110 (e.g., a battery in each of the slots 114). Next, the retaining member 110 is slidably or otherwise engaged with the cover 110, such that the opposing wall portions 126a, 126b and base 124 of the cover 110 surround the retaining member 110. During the sliding engagement of the retaining member 110 with the cover 120, the retaining housing 117 engagably fits within the latching mechanism 130.

More specifically, referring to FIGS. 6a-6c, as the retaining member 110 is slid within the cover 120, the one or more first latching members 142a, 142b (e.g., pair of fingers), are deflected by the ramps of the pair of directing members 144a, 144b. At the same time, the mating protrusion 111 slidably mates with the guide slot 121. As the retaining member 110 is slid further within the cover 120, the lips 141a,141b of the one or more first latching members 142a, 142b pass the edges of the directing member 144a, 144b and come into contact with the angled portions 148a, 148b of the pair of directing members 144a, 144b, as best shown in FIG. 6b. For example, because the angled portions 148a, 148b essentially decrease the width of the pathway that the pair of fingers 142a, 142b travel, a biasing inward force promotes inward deflection of the pair of fingers 142a, 142b, as the retaining member 110 continues to be pushed into the latch mechanism 130. Furthermore, because the pair of fingers 142a, 142b may be made of a resiliently deformable material, for example, as the lips 141a, 141b of the pair of fingers 142a, 142b slide down the angled portions 148a, 148b of the pair of directing members 144a, 144b, the ends of the pair of fingers 142a, 142b will be temporarily deflected toward each other.

Referring to FIG. 6c, as the retaining member 110 is further slid into the latching mechanism 130, the deflected pair of fingers 142a, 142b will pass between the pair of directing members 144a, 144b. Once the lips 141a, 141b of the pair of fingers 142a, 142b completely pass the pair of directing members 144a, 144b, the resiliency of the material will cause the pair of fingers 142a, 142b to biasedly return to a non-deflected position. In this position, the lips 141a, 141b of the pair of fingers 142a, 142b engage with the one or more second latching members 147a, 147b (see FIG. 5). In this position the retaining member 110 has been fully inserted into the latching mechanism 130. Thus, if the user or other force attempts to cause the retaining member 110 to slide in a direction away from the latching mechanism 130, because the lips 141a, 141b of the pair of fingers 142a, 142b are engaged with one or more second latching members 147a, 147b, the retaining member 110 will be unable to move. Furthermore, in the engaged position, the mating protrusion 111 is fully mated with the guide slot 121, thereby imparting additional security and stabilization of the retaining member 110 within the cover 120. If the portable electronic device or the cassette is dropped in the engaged position, for example, the sliding member 110 will remain securely retained in the cover 120 via the latching mechanism 130.

If the power source needs replacing, the user disengages the retaining member 110 from the latching mechanism 130, and then slides the retaining member 110 out of the cover 120. As described above, simply applying force on the retaining member 110 in a direction away from the latching mechanism 130 will not move the retaining member 100 because the lips 141a, 141b of the pair of fingers 142a, 142b are engaged with one or more second latching members 147a, 174b. Therefore, the user of the cassette 100 must first disengage the retaining member 110 from the latching member 130 by actuating the pair of latches 132a, 132b. Referring to FIGS. 2, 3, 4, 5, and 6c, an inward force must be contemporaneously applied against the actuation portion 131a, 131b of the pair of latches 132a, 132b. By applying this force, the pair of latches 132a, 132b will slide within the passage 135 in a direction toward the pair of fingers 142a, 142b. As the pair of latches 132a, 132a slide within the passage 135, the engagement portion 133a, 133b of the pair of latches 132a, 132a will eventually come into contact with the lips 141a, 141b of the pair of fingers 142a, 142b. The user must continue pushing the pair of latches 132a, 132b with enough force to overcome the natural resiliency of the pair of fingers 142a, 142b. The island 146 prevents over actuation of the pair of fingers 142a, 142b because once the pair of fingers 142a, 142b come into contact with the island 146, further deflection is impossible. Furthermore, the island is ramped 146a, 146b to guide the pair of fingers 142a, 142. Once the natural resiliency of the pair of fingers 142a, 142b have been overcome, the pair of fingers 142a, 142b will slide against the angled portions 148a, 148b of the pair of directing members 144a, 144b in a direction away from the latch mechanism 130.

The two latch design provides the additional advantage of only allowing disengagement of the retaining member 110 from the latch mechanism 130 when both of the pair of latches 132a, 132b are actuated contemporaneously. For example, if only one of the pair of latches 132a, 132b are actuated, only the single corresponding finger 142a, 142b will deflect. The other finger 142a, 142b corresponding to the non-actuated latch 132a, 132b will remain securely engaged with the one or more second latching members 147a, 147b. This engagement force retains the retaining member 110 in the latch mechanism 130. Thus, the dual latch design prevents accidental disengagement of the retaining member 110 when only one of the pair of latches 132a, 132b is accidentally actuated. Furthermore, it is unlikely that an user of the cassette would accidentally actuate both of the pair of latches. However, in another aspect, a single latch actuation design may be used if easier disengagement of the retaining member 110 from the latching mechanism 130 is desirable.

After the pair of latches 132a, 132b have been actuated and the retaining member 110 has returned to the position shown in FIGS. 6a, the user need only apply a slight sliding force on the retaining member 110 in a direction away from the latching mechanism 130 to fully disengage the retaining member 110 from the cover 120. Once the retaining member 110 has been completely disengaged from the cover 120, the user may then replace the power source and repeat the power source installation steps described above.

Exemplary aspects have now been described in accordance with the above advantages. It will be appreciated that these examples are merely illustrative of the aspects of the invention. Many variations and modifications will be apparent to those skilled in the art. For example, while the retaining member 110 is shown in the Figures and described above as having a rectangular shape, any suitable shape may be used as long as the member 110 has a shape as necessary to retain the power source and circuitry. In particular, the Figures are based around AA type batteries, and it should be understood that using a different sized power source and/or different arrangement of power sources could lead to different sizes and configurations of the retaining member 110 and the cover 120.

1. A cassette for retaining a power source for a portable electronic device, the cassette comprising:
a retaining member having a wall portion for retaining the power source;
a cover for matable engagement with the retaining member, the cover comprising a base portion configured to retainably engage with the wall portion;
one or more first latching members; and
one or more second latching members, wherein the one or more first latching members are resistibly engaged with the one or more second latching members when the base portion of the cover is engaged with the wall portion.

2. The cassette of claim 1, wherein the one or more first latching members comprise a pair of resilient fingers extending from the retaining member.

3. The cassette of claim 2, wherein the cover comprises a pair of directing members in alignment with the pair of resilient fingers, and wherein the one or more second latching members are defined by a portion of the pair of directing members.

4. The cassette of claim 1, further comprising:
one or more latches, wherein actuation of the one or more latches releases the engagement of the one or more first latching members with the one or more second latching members.

5. The cassette of claim 4, wherein the cover comprises a passage and wherein the one or more latches are disposed within the passage.

6. The cassette of claim 5, wherein the one or more latches comprise a pair of latches, and wherein only contemporaneous actuation of the pair of latches releases the engagement of the one or more first latching members with the one or more second latching members.

7. The cassette of claim 1, wherein the one or more first latching members comprise a first engagement portion disposed at a first end, and wherein the first engagement portion matably engages the one or more second latching members.

8. The cassette of claim 4, wherein the one or more latches comprise an actuation portion and a second engagement portion, wherein actuation of the actuation portion causes the second engagement portion to contact the one or more first latching members.

9. The cassette of claim 8, wherein the one or more latches comprise a pair of latches, and wherein only contemporaneous actuation of the actuation portion releases the engagement of the one or more first latching members with the one or more second latching members

10. The cassette of claim 3, wherein the one or more directing members comprise a ramp portion.

11. The cassette of claim 9, wherein the one or more first latching members deflect when the one or more first latching members contact the ramp portion of the one or more directing members.

12. The cassette of claim 1, wherein the one or more first latching members deflect when an inward force is applied and return to a non-deflected state when the force is removed.

13. The cassette of claim 1, wherein the one or more latches comprise a first protruding portion configured to retainably engage with a second protruding portion, and wherein the second protruding portion is integrally formed with the cover.

14. The cassette of claim 1, wherein the retaining member further comprises at least one electrical contact.

15. A method of engaging a cassette for retaining for use as a power source for a portable electronic device having a retaining member having a wall portion for retaining the power source; a cover for matable engagement with the retaining member, the cover comprising a base portion configured to retainably engage with the wall portion; one or more first latching members; and one or more second latching members, the method comprising:
engaging the retaining member with the base portion of the cover;
sliding the retaining member in a direction toward a first end of the cassette;
deflecting the one or more first latching members; and
engaging the one or more first latching members with the one or more second latching members.

16. The method of engaging a cassette of claim 15, wherein deflecting the one or more first latching members further comprises:
contacting a first engagement portion of the one or more first latching mechanisms with a ramped portion of one or more directing members.

17. The method of engaging a cassette of claim 15, wherein the one or more first latching members are biased to engage with the one or more second latching members.

18. The method of engaging a cassette of claim 15, further comprising:
attaching the retaining member to a portable electronic device.

19. The method of engaging a cassette of claim 15, further comprising:
inserting at least one power source into the retaining member.

20. The method of engaging a cassette of claim 19, wherein the at least one power source comprises at least one battery.

21. A method of refreshing power to a cassette that retains a power source for a portable electronic device having a retaining member having a wall portion for retaining the power source; a cover matably engaged with the retaining member, the cover comprising a base portion retainably engaged with the wall portion; one or more first latching members engaged with one or more second latching members; and one or more latches, the method comprising:
contemporaneously actuating the one or more latches, such the one or more first latching members disengage with the one or more second latching members;
disengaging the retaining member from the cover.

22. The method of operating a cassette of claim 21, wherein actuating the one or more latches further comprises:
deflecting the one or more first latching members.
